(19) United States
(12) Patent Application Publication
(10) Pub. No.: US 2004/0254828 A1
(43) Pub. Date: Dec. 16, 2004

(54) Information offering apparatus, information offering method, program and product

(76) Inventors: Tsuyoshi Yokota, Shiojiri-shi (JP); Hideki Makiyama, Nagano-ken (JP); Yasushi Noguchi, Shiojiri-shi (JP)

Correspondence Address: HARNESS, DICKEY & PIERCE, P.L.C., P.O. BOX 828, BLOOMFIELD HILLS, MI, 48303, US

(21) Appl. No.: 10/767,852

(22) Filed: Jan. 29, 2004

(30) Foreign Application Priority Data
Jan. 29, 2003 (JP) 2003-020744

(51) Int. Cl. G06F 17/60

(52) U.S. Cl. 705/10

(57) ABSTRACT

In shipping a computer ordered by selecting parts on a sales site offered by a sales management server, a shortcut link incorporating part codes as parameters of a URL on the support information site offered by a FAQ server, is set on a desktop screen of the computer. On the other hand, part codes, questions probable to arouse concerning the parts and answers thereto are registered as data in a database. When the short-cut link is selected on the desktop screen of the computer, the FAQ server accessible via a web management server obtains part codes from the URL, and sends the data picked up from the database by using the part codes, as a FAQ page, to the side of the user.

### RELATED APPLICATIONS

The present application claims priority to Japanese Application No. 2003-020744 filed Jan. 29, 2003 which is hereby expressly incorporated by reference in its entirety.

### BACKGROUND OF THE INVENTION

1. Technical Field

This invention relates to an information offering apparatus, an information offering method, a program and a product. More specifically, the invention relates to an information offering apparatus which offers, via a communication network, information to a user of a product produced by a combination of parts selected from a plurality of parts, an information offering method thereof, a program used for the information offering apparatus, and a product produced by a combination of parts selected from a plurality of parts.

2. Related Art

As an information offering apparatus, there has heretofore been proposed one which transmits a set of question items that have been prepared in advance as so-called “frequently asked questions” and answers thereto to a source of requesting the offer of information via a communication network (see, for example, JP-A-2002-56175 (FIG. 1, FIG. 2)).

With the above information offering apparatus, however, when a user is to be provided with information of a product constituted by parts selected from a plurality of parts, the number of parts is so large that the user must execute cumbersome operations so that the user is provided with proper information. Assuming that the product is, for example, a computer, and when the user attempts to obtain information concerning the CPU of his own computer, then, the user is required to correctly input the name of the manufacturer of the corresponding CPU, model number and the like to obtain proper information.

The information offering apparatus and the information offering method of the present invention have an object of providing proper information of a product constituted by parts selected from a plurality of parts without the need of cumbersome input. Further, the information offering apparatus and the information offering method of the present invention have an object of quickly providing proper information of a product constituted by parts selected from a plurality of parts. A program of the invention has an object of operating a computer as an information offering apparatus for quickly offering proper information of a product constituted by parts selected from a plurality of parts without cumbersome input. The product of the invention has an object of being quickly provided with proper information from the information offering apparatus.

### SUMMARY

The information offering apparatus, information offering method, program and product of the invention employ the following means in order to achieve at least some of the above objects.

An information offering apparatus of this invention is for offering, via a communication network, information to a user of a product produced by combining parts selected from a plurality of parts, comprising:

a question-and-answer items storage unit for storing question-and-answer items including questions for each of the plurality of parts and answers for the questions;

request-receiving means for receiving the request of offering information of the product from the user via the communication network;

information-obtaining means for obtaining part-related information related to the part constituting the product in response to the receipt of the request;

pick-up means for picking up, from the question-and-answer items storage means, at least one question-and-answer item related to the part constituting the product based on the part-related information that is obtained; and

transmission means for transmitting the question-and-answer item that is picked up to the user who has issued the request.

The information offering apparatus of this invention receives the request of offering information of the product from the user via the communication network, and obtains part-related information related to the part constituting the product in response to the receipt of the request. Then, based on the part-related information that is obtained, at least one question-and-answer item related to the part constituting the product is picked up from the question-and-answer item storage means storing the question-and-answer items including questions for each of the plurality of parts and answers for the questions, and the question-and-answer items that are picked up are transmitted to the user who has issued the request. That is, the corresponding question-and-answer items are picked up and transmitted based on the part-related information related to the part constituting the product that is obtained. As a result, the user is provided with proper information of the product.

In the information offering apparatus of the present invention, the information-obtaining means is one for obtaining the part-related information from the information received upon the receipt of the request for offering information of the product from the request-receiving means. Then, the part-related information is obtained upon receipt of the request, and proper information for the product can be quickly offered without the need of inputting part-related information.

In the information offering apparatus of an embodiment of the invention that receives the part-related information together with the request, the product may be one that is constituted so as to request the offer of information of the product for the information offering apparatus via the communication network, and transmit part-related information in response to the request. Then, the user simply requests the offer of information from the product via the communication network to quickly obtain proper information of the product at the time of request.

In the information offering apparatus of the embodiment of the invention that receives the part-related information together with the request, the request may include request information for offering information from the information offering apparatus via the communication network and the part-related information. Then, the part-related information can be easily received in response to the request for offering information. In the information offering apparatus of this embodiment of the invention, the product may be a computer, and the request may be executed by using a short-cut link set on the desktop screen of the product.

In the information offering apparatus of the embodiment of the invention that receives the part-related information together with the request, the part-related information may be stored in the product at the time of producing the product. Then, the user need not input the part-related information at all.

The information offering apparatus of the invention comprises related information storage means for storing product identification information in relation to part-related information of the product, wherein the request-receiving means is one for receiving product identification information in response to the receipt of the request, and the information-obtaining means is one for obtaining corresponding part-related information from the related information storage means based on identification information that is received. Then, there are obtained the part-related information based on the product identification information received together with the request, and proper information of the product can be quickly offered without the need of inputting the part-related information.

In the information offering apparatus of the embodiment of the invention that receives the product identification information together with the request, the product may be one that is constituted so as to request the offer of information of the product for the information offering apparatus via the communication network, and transmits product identification information in response to the request at the time of request. Then, the user simply requests the offer of information from the product via the communication network to quickly obtain proper information of the product.

In the information offering apparatus of the embodiment of the invention that receives the product identification information together with the request, the request may include request information for offering information from the information offering apparatus via the communication network and product identification information. This makes it possible to easily receive product identification information in response to the request for offering information. In the information offering apparatus of this embodiment of the invention, the product is a computer, and the request is executed by using a short-cut link set on the desktop screen of the product.

In the information offering apparatus of the embodiment of the invention that receives the product identification information together with the request, the identification information is stored in the product at the time of producing the product. Then, the user need not input the product identification information at all.

A program for an information offering apparatus of the invention is for operating a computer as an information offering apparatus according to any one of the above embodiments of the invention, i.e., for operating the computer basically as an information offering apparatus for offering, via a communication network, information to a user of a product produced by combining parts selected from a plurality of parts, comprising a question-and-answer items storage unit for storing question-and-answer items including questions for each of the plurality of parts and answers for the questions, request-receiving means for receiving the request of offering information of the product from the user via the communication network, information-obtaining means for obtaining part-related information related to the part constituting the product in response to the receipt of the request, pick-up means for picking up, from the question-and-answer items storage means, at least one question-and-answer item related to the part constituting the product based on the part-related information that is obtained, and transmission means for transmitting the question-and-answer item that is picked up to the user who has issued the request.

The program for the information offering apparatus of the invention operates the computer as the information offering apparatus of any one of the embodiments of the invention, making it possible to obtain the effect of the information offering apparatus of the invention, such as providing the user with proper information of the product and quickly providing the user with proper information of the product without the need of inputting part-related information.

An information offering method of the invention is for offering, via a communication network, information to a user of a product produced by combining parts selected from a plurality of parts, and comprises:

(a) storing, in advance, a plurality of question-and-answer items including questions for each of the plurality of parts and answers for the questions;

(b) obtaining part-related information related to the part constituting the product in response to the receipt of a request when the request is received from the user for offering information of the product via the communication network;

(c) picking up, from a plurality of question-and-answer items that are stored, at least one question-and-answer item related to the part constituting the product based on the part-related information that is obtained; and

(d) transmitting the question-and-answer item that is picked up to the user who has issued the request.

According to the information offering method of the invention, part-related information related to the part constituting the product is obtained in response to the receipt of a request when the request is received from the user for offering information of the product via the communication network, at least one question-and-answer item related to the part constituting the product is picked up from a plurality of question-and-answer items that are stored in advance based on the part-related information that is obtained, and the question-and-answer item that is picked up is transmitted to the user who has issued the request. Thus, the user is provided with proper information of the product.

In the information offering method of this invention, the step (b) may be one for obtaining the part-related information from the information received upon the receipt of the request. Then, the user simply requests the offer of information from the product via the communication network to quickly obtain proper information of the product.

In the information offering method of this invention, product/part-related information is stored, in advance, in which product identification information is related to part-related information of the product, and the step (b) may be one for receiving product identification information in response to the receipt of the request, and obtaining corresponding part-related information based on product/part-related information stored depending upon identification information that is received. Then, there is obtained part-related information based on the product identification information received together with the request, and proper information of the product can be quickly offered without the need of inputting the part-related information.

A product of the invention is produced by a combination of parts selected from a plurality of parts, and comprises request information transmission means for requesting the offer of information of the product to an information offering apparatus capable of offering information of the product via a communication network, and for transmitting information related to the part constituting the product in response to the request.

The product of this invention requests the offer of information of the product to an information offering apparatus capable of offering information of the product via a communication network, and transmits information related to the part constituting the product in response to the request. Therefore, proper information of the product is quickly obtained from the information offering apparatus.

The product of the invention may be a computer, and the request information transmission means may be one that executes the request and transmission by using a short-cut link in which the request information for requesting the information offering apparatus to offer information via the communication network is related to the part-related information of the product. Then, it may be simply requested to offer information by using the short-cut link to obtain proper information of the product. In the product of the embodiment of this invention, the short-cut link may be set on the desktop screen of the product. Then, the user who has purchased the product is allowed to easily request the offer of information by using the short-cut link.

### BRIEF DESCRIPTION OF THE DRAWINGS

FIG. 1 is a configuration view illustrating the configuration of a sales management system 30.

FIG. 2 is an explanatory view illustrating an example of a purchasing page of a sales site.

FIG. 3 is an explanatory view illustrating an example of order information.

FIG. 4 is a flowchart illustrating an example of FAQ processing.

FIG. 5 is an explanatory view illustrating an example of knowledge data.

FIG. 6 is an explanatory view illustrating an example of a knowledge selection page.

FIG. 7 is an explanatory view illustrating an example of a FAQ page.

### DETAILED DESCRIPTION

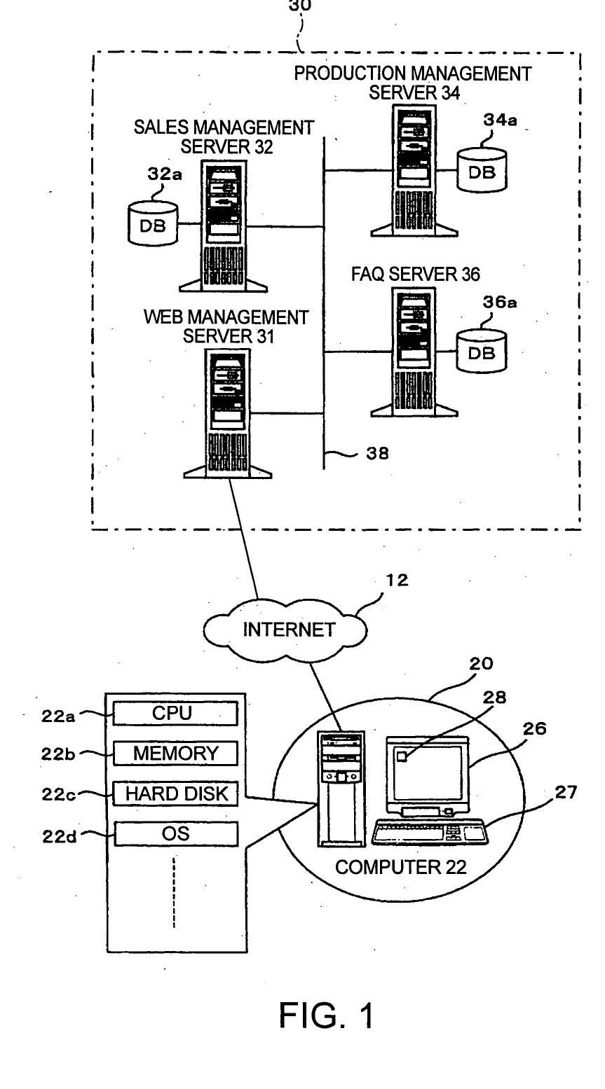

Next, embodiments of the invention will be described below. FIG. 1 is a configuration view schematically illustrating the configuration of a product management system 30 equipped with a FAQ server 36 which is an information offering apparatus according to an embodiment of the invention. The product management system 30 of this embodiment includes a web management server 31 connected to a computer 22 of a user 20 via an internet 12, a sales management server 32 connected to the web management server 31 through a LAN 38, a production management server 34 similarly connected through the LAN 38, and a FAQ server 36 similarly connected through the LAN 38.

The web management server 31 is constituted as an internet server having a fire wall function, and offers, to the side of the internet 12, the sales sites offered by the sales management server 32 and the support information site offered by the FAQ server 36.

The sales management server 32 is so constituted as to offer web sites of the BTO (build to order) sales system capable of optionally specifying and ordering, out of a plurality of kinds of parts, the kinds of parts such as the kind of CPU, capacity of the memory, capacity of the hard disk device, kind of OS (operation system) and kind of application software when the user 20 of the computer 22 connected to the internet 12 purchases computer products on an on-line basis. The sales management server 32 is equipped with a sales management database 32a for storing information (parts information such as of CPU, memory, etc.) necessary for the BTO sales system. Upon receipt of order information from the user 20, the sales management server 32 imparts a specific serial number for each of the order information, and sends it to the production management server 34 through the LAN 38. Here, the order information includes product data such as the model name of the product that is purchased and designation information for specifying the kind of the part designated by the user 20, personal data such as the name, address, telephone number, e-mail address of the user 20, and the method of payment of fees.

The production management server 34 is constituted for managing the steps of producing the computer product based on order information output from the sales management server 32, and includes a production management database 34a for storing order information, information related to the steps of production and information related to the shipping.

The FAQ server 36 is so constituted as to offer support information sites for offering support information to the user 20 of the computer 22 connected to the internet 12 via the web management server 31, and includes a FAQ database 36a for storing knowledge data comprising questions for each of the parts constituting the computer product and answers thereto.

The computer 22 of the user 20 is one purchased from a sales site offered by the sales management server 32, and is assembled by using CPU 22a, memory 22b, hard disk 22c, operation system (sometimes abbreviated as OS) 22d, monitor 26 and keyboard 27 specified in the BTO. On the desktop screen of the computer 22, there is set a short-cut link (icon) 28 incorporating information related to a part that constitutes the computer 22 as a URL parameter of the support information site offered by the FAQ server 36.

Described next is the operation of the thus constituted product management system 30 of the embodiment and, particularly, the operation of the FAQ server 36. Prior to describing the operation of the FAQ server 36, briefly described below, first, are the operations of the sales management server 32 and of the production management server 34.

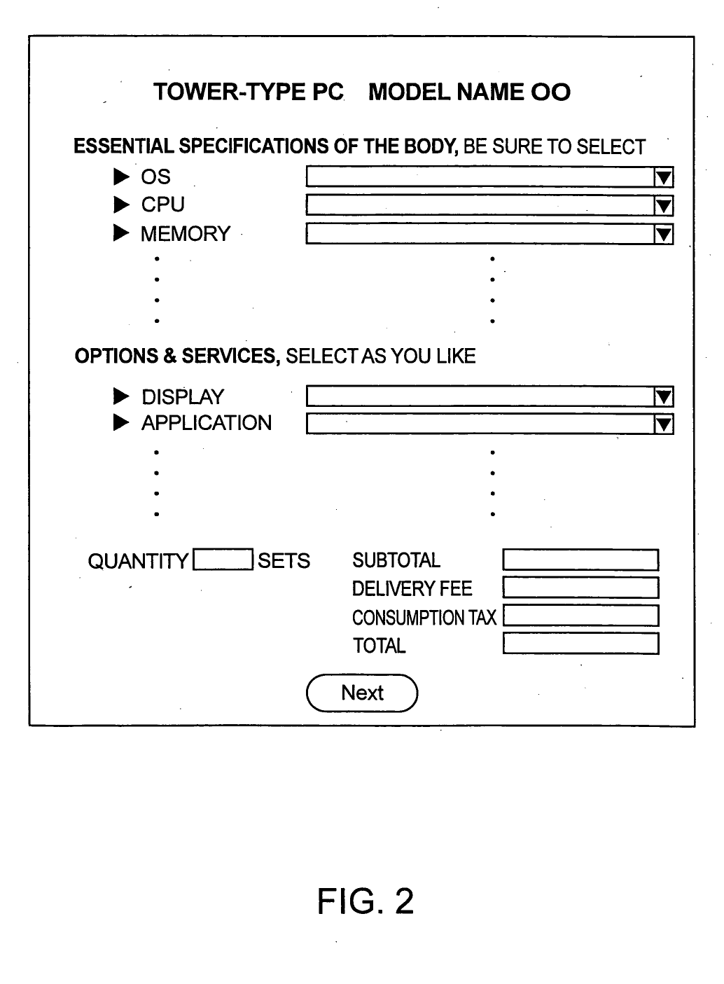

FIG. 2 illustrates an example of a purchase page of a sales site of the BTO sales system offered by the sales management server 32. On the screen as shown, there are provided columns of “ESSENTIAL SPECIFICATIONS OF THE BODY” for specifying essential items, i.e., for specifying such parts as “OS”, “CPU”, “MEMORY”, etc. by using a pull-down menu, and a column of “OPTION & SERVICE” for specifying optional items, i.e., for specifying optional items such as “DISPLAY” and “APPLICATION” by using a pull-down menu. When the part is specified by the pull-down menu in each column, the price of the specified part is reflected on the column of “Subtotal”, on the column of “Consumption Tax” and on the column of “Total”. On the column of “Quantity”, “1” is set as a default value. When it is desired to purchase two or more units, the number of units can be input. After the input of each item, “Next” button is clicked, whereby there appears an input screen that is not illustrated for specifying a method of payment. When the method of payment is specified, there further appears an input screen that is not illustrated for inputting personal data, such as the name, address and the like of the user 20. After each data have been input, an order button is clicked. Then, order information input by the user 20 via the internet 12 is transmitted from the computer 22 to the sales management server 32 via the web management server 31. Upon receipt of the order information, the sales management server 32 imparts a serial number to the order information and outputs it to the production management server 34 through the LAN 38.

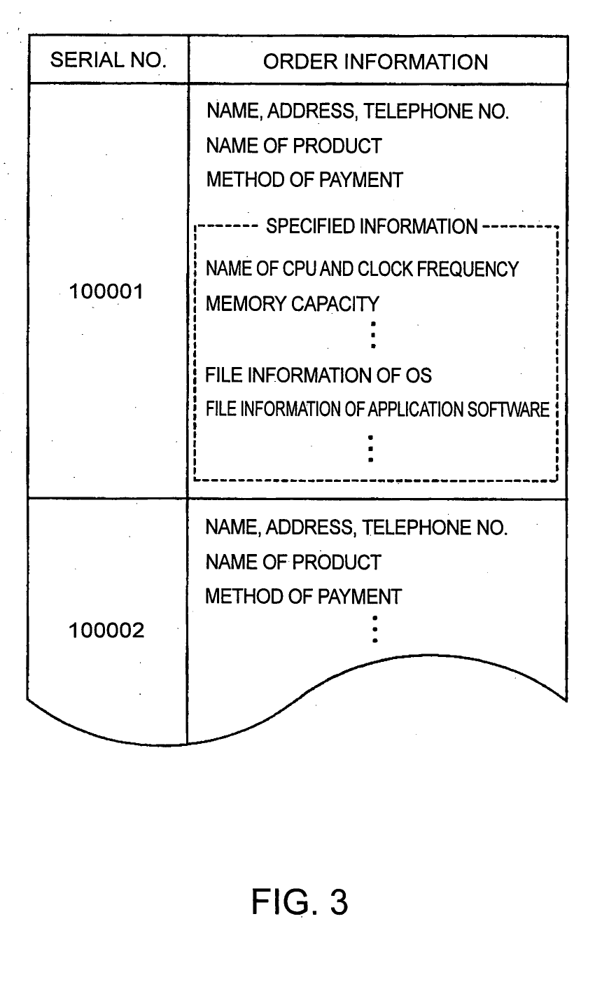

The production management server 34 registers, into the production management database 34a, the order information that is input in relation to the serial number imparted with the order information. FIG. 3 illustrates an example of order information registered into the production management database 34a. Upon registering the order information to the production management database 34a, the production management server 34 sends an instruction of assembling to a client computer in an assembly plant (not shown) connected to the LAN 38 so as to assemble a computer based on the order information. In the assembly plant, parts are picked up and assembled based on the assembling instruction, and information related to the steps and shipment is input through the client computer that is not shown and is transmitted to the production management server 34. An inspection program has been installed in the client computer in the assembling plant for inspecting whether the computer is assembled in accordance with the assembling instruction, and the computer that is assembled is inspected. After having passed the inspection, the client computer sets, to the desktop screen of the assembled computer, a short-cut link (that will be described later) in which the part cords of the assembled computer are incorporated as parameters of a URL on a support information site offered by the FAQ server 36 and, besides, information of the completion of inspection is output to the production management server 34 so as to be registered to the production management data base 34a.

When information of the completion of inspection is input, the production management server 34 registers information of the completion of inspection to the production management database 34a in relation to the corresponding order information, forms an e-mail including information for notifying the shipment and a link which is the same as the short-cut link set on the desktop screen of the computer assembled by the client computer, and transmits the e-mail to the mail address of the user 20.

The above computer 22 of the user 20 is ordered through a sales site of the sales management server 32 described above, and is assembled by the client computer in the assembling plant. Then, after having passed the inspection, a short-cut link 28 is set on the desktop screen, and the computer 22 is delivered to the user 20. An example of the short-cut link 28 is illustrated below. In the short-cut link 28:

“http://support.*****.co.jp/faq/”

is a URL of the support information site offered by the FAQ server 36, and parameters after “?” in:

“?com***,win***,cpu***, - - - ”

are part codes representing the kind of the computer body, kind of the OS, kind of the CPU and the like.

http://support.*****.co.jp/faq/?com***,win***,cpu***, - - - ”

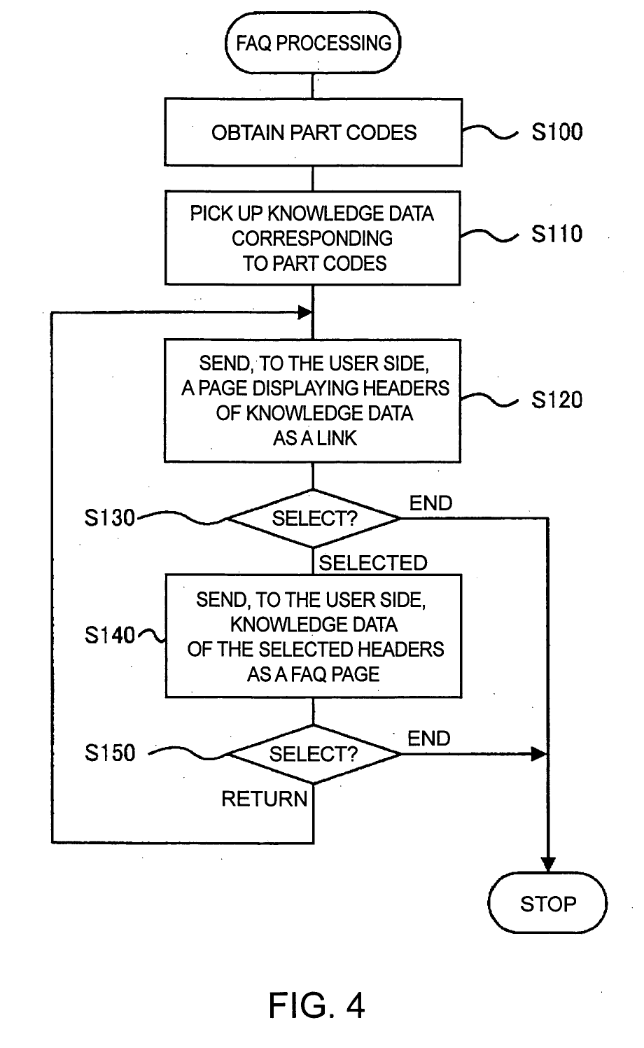

Next, described below is the operation of the FAQ server 36. FIG. 4 is a flowchart illustrating one example of FAQ processing executed by the FAQ server 36. The FAQ processing is executed when the short-cut link 28 set on the desktop screen of the computer 22 is clicked by the user 20 or when a short-cut link included in the e-mail transmitted to the user 20 at the time of shipping the computer 22 is clicked by the production management server 34, and when the FAQ server 36 is accessed via the web management server 31.

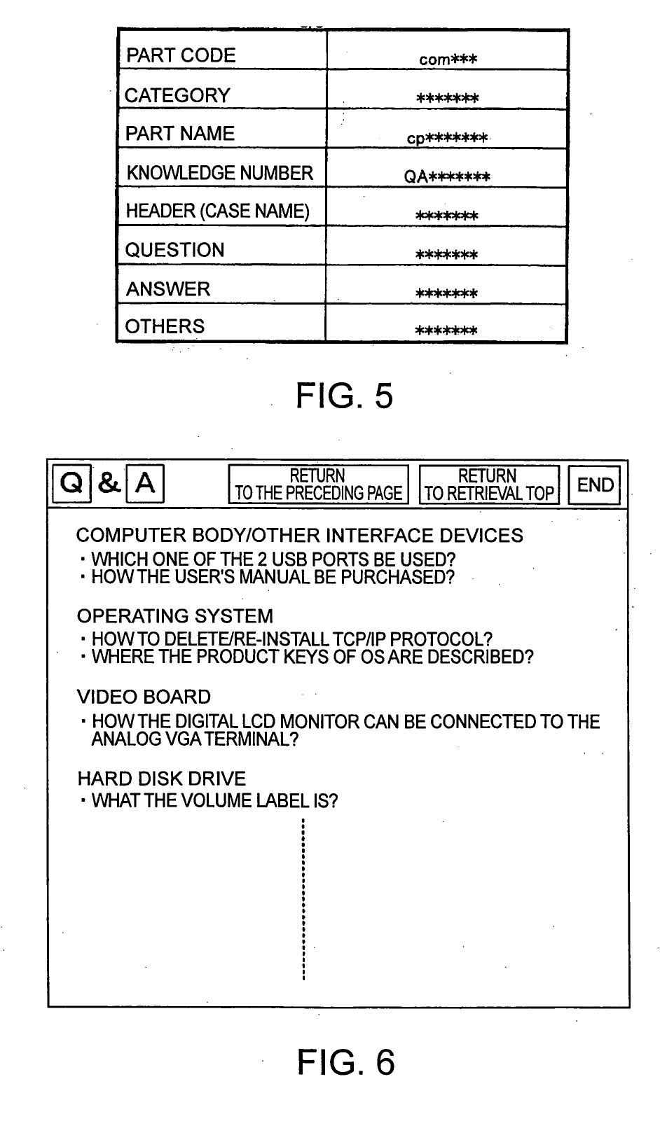

In the FAQ processing, first, parameters after “?” included in the short-cut link 28 are input to obtain part codes of parts for constituting the computer 22 of the user 20 (step S100), and processing is executed for picking up, from the FAQ database 36a, knowledge data corresponding to each part code with the obtained part codes as keys (step S110). FIG. 5 illustrates an example of knowledge data. In the example of FIG. 5, knowledge data include part code, category, part name, knowledge number, header (case name), question, answer, etc.

Next, a knowledge selection page, which displays a list of headers (case names) of the knowledge data that are picked up, and are linked, is output to the user 20 side (step S120), and waits until the headers are selected by the user 20 (step S130). FIG. 6 illustrates an example of a knowledge selection page. In the example of FIG. 6, a list of headers (case names) is displayed for every category in the knowledge data.

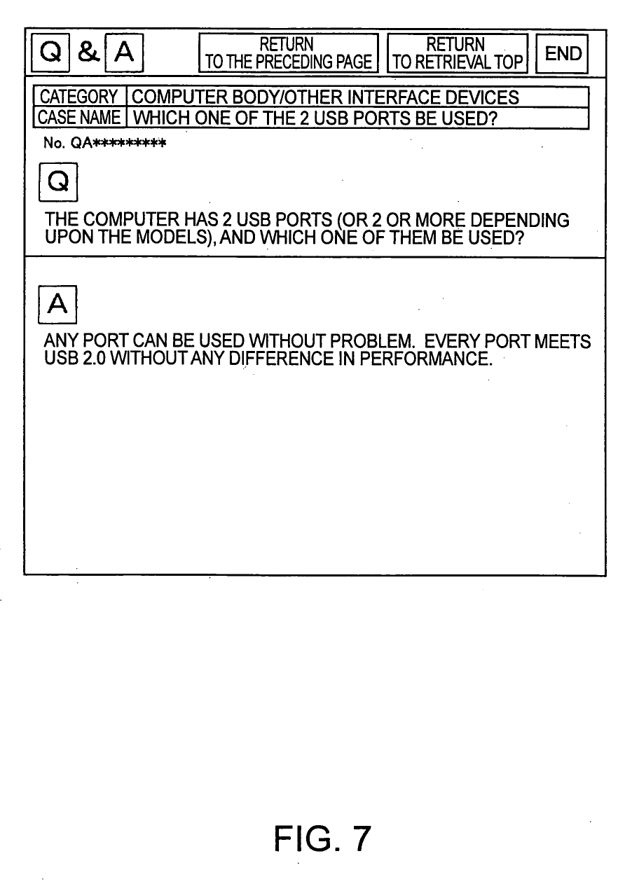

When any header is selected by the user 20 from the knowledge selection page, the knowledge data of the selected header are output as a FAQ page to the user 20 side (step S140). FIG. 7 illustrates an example of a FAQ page. The example of FIG. 7 is a FAQ page that is displayed when there is selected a header “• Which one of the 2 USB ports be used?” of a category “Computer body/Other interface devices” on the knowledge selection page illustrated in FIG. 6, and there are shown corresponding category and header (case name), knowledge number, question and answer. The item “Others” of the knowledge data is displayed under the answer. In the example of FIG. 7, however, the item “Others” is not displayed since no data exists therein.

When “Return to the preceding page” button is selected on the FAQ page, the steps return back to step S120 where a knowledge selection page is output. When the “End” button is clicked on the knowledge selection page or on the FAQ page, the FAQ processing ends.

According to the FAQ server 36 of the above embodiment, the knowledge data corresponding to the part code of a part constituting the computer 22 is picked up from the FAQ database 36a, and proper information can be offered to the computer 22 of the user 20. Besides, a part code is obtained from the parameter of the short-cut link included in an e-mail transmitted from either the short-cut link 28 set on the desktop screen of the computer 22 or the production management server 34 to the user 20 at the time of shipping. By simply clicking the short-cut link, therefore, the user 20 is allowed to be quickly provided with information adapted to the computer 22 without the need of inputting information related to the parts that constitute the computer 22.

Here, in the FAQ server 36 of this embodiment, the FAQ database 36a corresponds to question-and-answer items storage means, and the processing for starting the FAQ processing corresponds to request-receiving means which starts working on demand upon clicking the short-cut link 28 set on the desktop of the computer 22 or upon clicking the short-cut link included in an e-mail transmitted from the production management server 34 to the user 20. Further, information-obtaining means corresponds to processing for obtaining the part codes from the parameters of the shortcut link at step S100 in the FAQ processing illustrated in FIG. 4, similarly, pick-up means corresponds to processing for picking up knowledge data at step S110 in the FAQ processing and, similarly, transmission means corresponds to processing for transmitting, to the user 20, a FAQ page at step S140 in the FAQ processing.

Further, the computer 22 of the user 20 described in the embodiment corresponds to a product produced by a combination of parts selected from a plurality of parts, and the short-cut link 28 set on the desktop screen of the computer 22 corresponds to request information transmission means.

In the production management server 34 of this embodiment, when the computer 22 is assembled and passes the inspection, an e-mail is transmitted to the user 20 that includes the information for notifying the shipping and the short-cut link in which the part codes of the computer 22 are incorporated as parameters of a URL on the support information site offered by the FAQ server 36. However, an e-mail only including information for notifying the shipment without the short-cut link, may be transmitted to the user 20.

In this embodiment, the short-cut link 28 incorporating the part codes of the computer 22 as parameters of a URL on the support information site offered by the FAQ server 36, was set on the desktop screen of the computer 22. The short-cut link 28, however, may be set anywhere other than the desktop screen.

In this embodiment, the short-cut link 28 incorporating the part codes of the computer 22 as parameters of a URL on the support information site offered by the FAQ server 36, was set on the desktop screen of the computer 22. Instead of the part codes of the computer 22, however, a short-cut link incorporating a serial number of the computer 22 as a parameter may be set on the desktop screen. In this case, the serial number of the computer received from order information accepted by the sales management server 32 and the part codes of parts constituting the computer are obtained and are stored in the database 46a, in advance. When the serial number is received, part codes of parts constituting the computer of the above serial number are retrieved and obtained. Or, the serial number is handed over to the sales management server 32, and the parts codes of parts constituting the computer corresponding to the serial number are obtained from the order information registered to the sales management database 32a and are transmitted through the production management server 34.

In this embodiment, it was described that the computer 22 of the user 20 was ordered by the sales site of the sales management server 32 and was delivered to the user 20. However, the computer 22 of the user 20 may be assembled based on the order and, after having passed the inspection, may be delivered to the user 20 by setting the short-cut link 28 on the desktop screen. Therefore, the order is not limited to one by the sales site of the sales management server 32 but may be any one such as one over the telephone or one by using a facsimile.

In this embodiment, the computer was specifically described as a product assembled by using parts selected from a plurality of parts. The embodiment, however, can be applied to any product assembled by using parts selected from the plurality of parts. In particular, the embodiment can be preferably applied to a product that can be connected to the internet 12 and that is capable of obtaining information therethrough.

In this embodiment, the invention related to offering information of the form of the FAQ server 36, but may further be described in the form of a method of offering information related to the product or in the form of a program that operates the computer as the FAQ server 36 of the embodiment, as a matter of course. When the form of the program is employed, steps in the FAQ process illustrated in FIG. 4 may be programmed by using a suitable language.

Though the invention was described above by way of an embodiment, it should be noted that the invention is in no way limited to the above embodiment only, but can be put into practice in various modifications without departing from the gist and scope of the invention.

What is claimed is:

1. An information offering apparatus for offering, via a communication network, information to a user of a product produced by combining parts selected from a plurality of parts, comprising:
question-and-answer items storage unit means for storing question-and-answer items including questions for each of the plurality of parts and answers for the questions;
request-receiving means for receiving a request for offering information of the product from the user via the communication network;
information-obtaining means for obtaining part-related information related to a part constituting the product in response to receiving the request;
pick-up means for picking up, from the question-and-answer items storage means, at least one question-and-answer item related to the part constituting the product based on the part-related information that is obtained; and
transmission means for transmitting the question-and-answer item that is picked up to the user who has issued the request.

2. The information offering apparatus according to claim 1, wherein said information-obtaining means comprises one for obtaining the part-related information from the information received upon receipt of the request for offering information of the product from said request-receiving means.

3. The information offering apparatus according to claim 2, wherein said product comprises one that is so constituted as to request the offer for information of the product for the information offering apparatus via the communication network, and transmits the part-related information in response to the request at the time of request.

4. The information offering apparatus according to claim 2, wherein the request includes request information for offering information from said information offering apparatus via the communication network and the part-related information.

5. The information offering apparatus according to claim 4, wherein said product comprises a computer, and said request comprises one that is executed by using a short-cut link set on a desktop screen of said product.

6. The information offering apparatus according to claim 3, wherein the part-related information is stored in the product at a time of producing said product.

7. The information offering apparatus according to claim 1, further comprising:
related information storage means for storing product identification information relating to part-related information of the product; wherein
said request-receiving means comprises one for receiving product identification information in response to the receipt of the request; and
said information-obtaining means comprises one for obtaining corresponding part-related information from said related information storage means based on identification information that is received.

8. The information offering apparatus according to claim 7, wherein said product comprises one that is so constituted as to request the offer for information of the product for the information offering apparatus via the communication network, and transmits product identification information in response to the request at the time of request.

9. The information offering apparatus according to claim 7, wherein the request includes request information for offering information from said information offering apparatus via the communication network and product identification information.

10. The information offering apparatus according to claim 9, wherein said product comprises a computer, and said request comprises one that is executed by using a short-cut link set on a desktop screen of said product.

11. The information offering apparatus according to claim 8, wherein the identification information is stored in the product at a time of producing said product.

12. A program for operating a computer as the information offering apparatus of claim 1.

13. An information offering method for offering, via a communication network, information to a user of a product produced by combining parts selected from a plurality of parts, comprising:
(a) storing, in advance, a plurality of question-and-answer items including questions for each of the plurality of parts and answers for the questions;
(b) obtaining part-related information related to a part constituting the product in response to receiving a request when the request is received from the user for offering information of the product via the communication network;
(c) picking up, from a plurality of question-and-answer items that are stored, at least one question-and-answer item related to the part constituting the product based on the part-related information that is obtained; and
(d) transmitting the question-and-answer item that is picked up to the user who has issued the request.

14. The information offering method according to claim 13, wherein said step (b) is one for obtaining the part-related information from the information received upon the receipt of the request.

15. The information offering method according to claim 13, further comprising storing, in advance, product/part-related information in which product identification information is related to part-related information of the product; wherein
said step (b) is one for receiving product identification information in response to the receipt of the request, and obtaining corresponding part-related information based on product/part-related information stored depending upon identification information that is received.

16. A product produced by a combination of parts selected from a plurality of parts, comprising:
request information transmission means for requesting an offer of information of the product to an information offering apparatus capable of offering information of the product via a communication network, and for transmitting information related to the part constituting the product in response to the request.

17. The product according to claim 16, wherein said product comprises a computer, and said request information transmission means comprises one that executes the request and transmission by using a short-cut link in which the request information for requesting the information offering apparatus to offer information via the communication network is related to the part-related information of the product.

18. The product according to claim 17, wherein said short-cut link is set on a desktop screen of said computer.
